(19) United States
(12) Patent Application Publication
(10) Pub. No.: US 2010/0161659 A1
(43) Pub. Date: Jun. 24, 2010

(54) INFORMATION SUPPLYING SERVER

(75) Inventor: Isao TAKEYASU, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/639,299

(22) Filed: Dec. 16, 2009

(30) Foreign Application Priority Data
Dec. 19, 2008 (JP) 2008-324079

(51) Int. Cl. G06F 17/30

(52) U.S. Cl. 707/770; 707/E17.014; 707/769; 707/E17.032

(57) ABSTRACT

An information supplying server includes a retrieval request receiver (101) for receiving a query containing a keyword, a retriever (102) for transmitting a received query to a retrieval server identified by a retrieval destination identifier associated with a superordinate concept of received keyword in retrieval destination data, and receiving a retrieved data from the retrieval server, a narrowing word determiner (103) for determining a narrowing word in accordance with a priority determined from a provisional priority set to a narrowing word candidate as a candidate of narrowing word for use to narrow down information from retrieved data, and a degree of relevancy set to a superordinate concept of narrowing word candidate and a superordinate concept of the keyword, and a supply data transmitter (107) configured to transmit to the client terminal a supply data as a synthesis of the retrieved data with a new query having a determined narrowing word combined with the received query.

### CROSS REFERENCE TO RELATED APPLICATIONS

The present application claims the benefit of priority under 35 U.S.C. §119 to Japanese Patent Application No. 2008-324079, filed on Dec. 19, 2008, the entire contents of which are incorporated herein by reference.

### BACKGROUND OF THE INVENTION

1. Field of Art

The present invention relates to an information supplying server adapted to supply information in response to a request.

2. Description of Relevant Art

Recent years have observed activated use of networks for supply of contents, such as delivery of audio data or delivery of video data. For such purposes, there are systems supplying contents of matters in various genres from contents suppliers, through networks, to terminals owned by users. Such contents tend to have increased varieties of substances and genres.

However, users want supply of desirable contents, and have to select matching contents from listings of titles or the like of enormous amounts of contents. Such listings of contents are devised, for instance, to classify contents by genres, or array contents in sequences of orders they are given, or in sequences of dates of their generation. But, it is still difficult for users to select matching contents from listings of enormous amounts of contents.

To this point, Japanese Patent Application Laid-Open Publication No. 2003-22277 has disclosed a technique of retrieving information in consideration of a broader concept or the like of retrieved words. This technique implements a matching process using a word of concern, together with a matching process with respect to a broader concept or the like of words contained in key document of retrieval. For results of retrieval to be stored, there also is consideration taken of a conceptual hierarchy between the word of concern and the words contained in key document of retrieval.

Further, for retrieval of a set of pieces of information, there is a technique disclosed in Japanese Patent Application Laid-Open Publication No. 2008-234559, where the set of pieces of information is efficiently refined to retrieve. This technique makes a morpheme element analysis of sentences contained in a set of pieces of information (in the form of a document), for extraction of words to be used in the order of occurrence frequency for refinement of information.

In addition, there is a technique disclosed in Japanese Patent Application Laid-Open Publication No. 2007-34466, which performs retrieval of information, presuming an object of retrieval to provide a combination of keywords as necessary. According to this technique, if a keyword input for retrieval corresponds to an event word associated therewith in advance, a relevant word of the event word is returned to provide a combination of keywords.

However, the foregoing techniques in the past provide general users with keywords relevant in the order of frequency of use or retrieval. Actually, users may want to retrieve those pieces of information that are not always high in frequency of use. For instance, according to the techniques in the past, some users may have, among others, desirable pieces of information dropped out of sets of retrieved information pieces, or such a set of information pieces that is too big to extract a desirable subset thereof, as an issue. The techniques in the past have thus failed to provide a retrieval method responsive to a word input by a user for retrieval, to narrow down a range of retrieval to a set of information pieces reflecting an intention of the user, as a problem. Besides, they might have an over-reduced range of retrieval, as another problem.

The present invention has been devised in view of such problems. It is an object of the present invention to provide an information supplying server adapted along with information retrieval to guide general users to a set of optimal information pieces, without undue burdens thereon.

### SUMMARY OF THE INVENTION

According to an aspect of the present invention, an information supplying server is configured to retrieve information matching a query composed of a keyword as a retrieval key word, to supply to a client terminal, the information supplying server comprising a retrieval destination data storer configured for storage of retrieval destination data for association of superordinate concepts of keywords, and retrieval destination identifiers for identification of retrieval servers adapted to supply information retrieved by a keyword of superordinate concept, a retrieval request receiver configured to receive a query containing a keyword from the client terminal, a retriever configured to transmit a received query to a retrieval server identified by a retrieval destination identifier associated with a superordinate concept of a received keyword in the retrieval destination data, and receive retrieved data from the retrieval server, a narrowing word determiner configured to determine a narrowing word in accordance with a priority determined from a provisional priority set to a narrowing word candidate as a candidate of narrowing word for use to narrow down information from retrieved data, and a degree of relevancy set to a superordinate concept of narrowing word candidate and the superordinate concept of keyword, and a supply data transmitter configured to transmit to the client terminal a supply data as a synthesis of the retrieved data with a new query having a determined narrowing word combined with the received query.

### BRIEF DESCRIPTION OF THE DRAWINGS

FIG. 1 is a functional block diagram of an information supplying server according to an embodiment of the present invention.

FIG. 2 is a time chart of actions in an information supplying method according to the embodiment of the present invention.

FIG. 3 is an illustration of an exemplary retrieval frame displayed on a client terminal.

FIG. 4 is an exemplary listing of data on superordinate concepts employed at the information supplying server.

FIG. 5A and FIG. 5B are exemplary listings of data on retrieval destinations employed at the information supplying server.

FIG. 6 is an exemplary listing of data on narrowing word candidates employed at the information supplying server.

FIG. 7 is an exemplary listing of data on relation strength employed at the information supplying server.

FIG. 8 is an exemplary listing of data on additional narrowing words employed at the information supplying server.

FIG. 9 is an exemplary listing of data for query update employed at the information supplying server.

FIG. 10 is a flowchart of actions in a retrieval request reception process at a retrieval request receiver.

FIG. 11 is a flowchart of actions in a retrieval process at a retriever.

FIG. 12 is a flowchart of actions in a retrieval destination selection process at the retriever.

FIG. 13 is a flowchart of actions in a narrowing word determination process at a narrowing word determiner.

FIG. 14 is a flowchart of actions in an additional narrowing word extraction process at an additional narrowing word extracter.

FIG. 15 is a flowchart of actions in a query update process at a query updater.

FIG. 16 is a flowchart of actions in a supply data generation process at a supply data generator.

FIG. 17 is an illustration of an exemplary retrieval result frame displayed on a client terminal.

FIG. 18 is an illustration of another exemplary retrieval result frame displayed on the client terminal.

FIG. 19A, FIG. 19B, and FIG. 19C are illustrations of other exemplary retrieval result frames displayed on the client terminal.

### DETAILED DESCRIPTION OF THE EMBODIMENTS

There will be described the preferred embodiments of the present invention with reference to the accompanying drawings. In the drawings, like elements are designated at like reference characters.

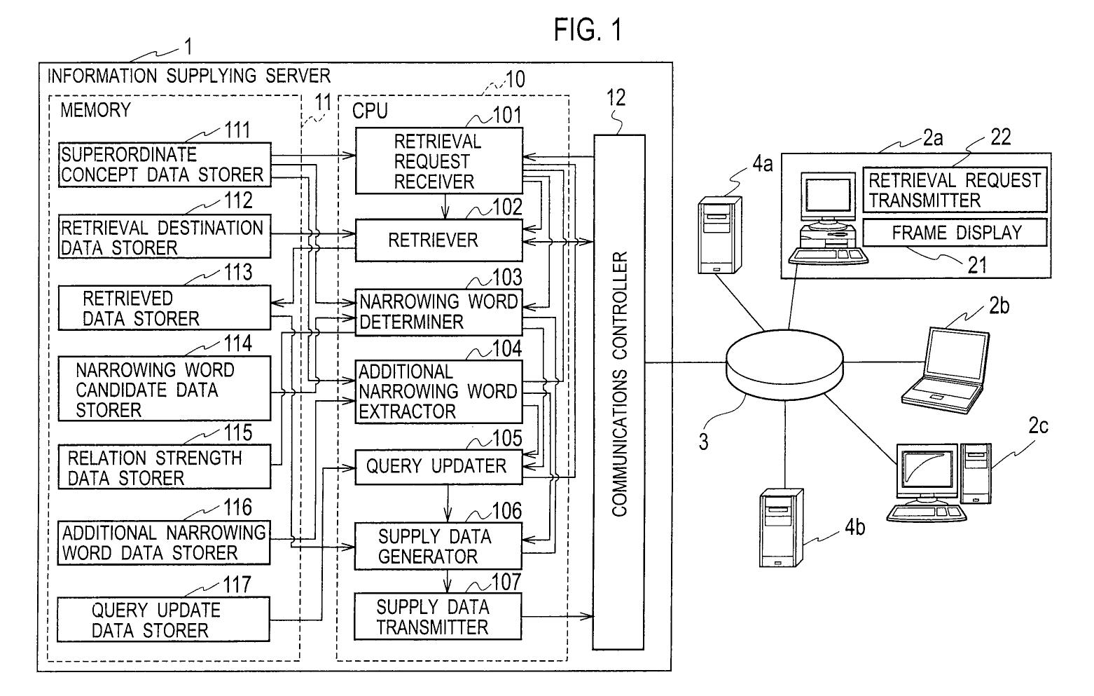

FIG. 1 shows an information supplying server 1 according to an embodiment of the present invention, that is mutually connected, through a communications network 3 such as the Internet, with client terminals 2a, 2b, and 2c and retrieval servers 4a and 4b, and adapted for retrievals upon requests to acquire pieces of information to be supplied to the client terminals 2a, 2b, and 2c.

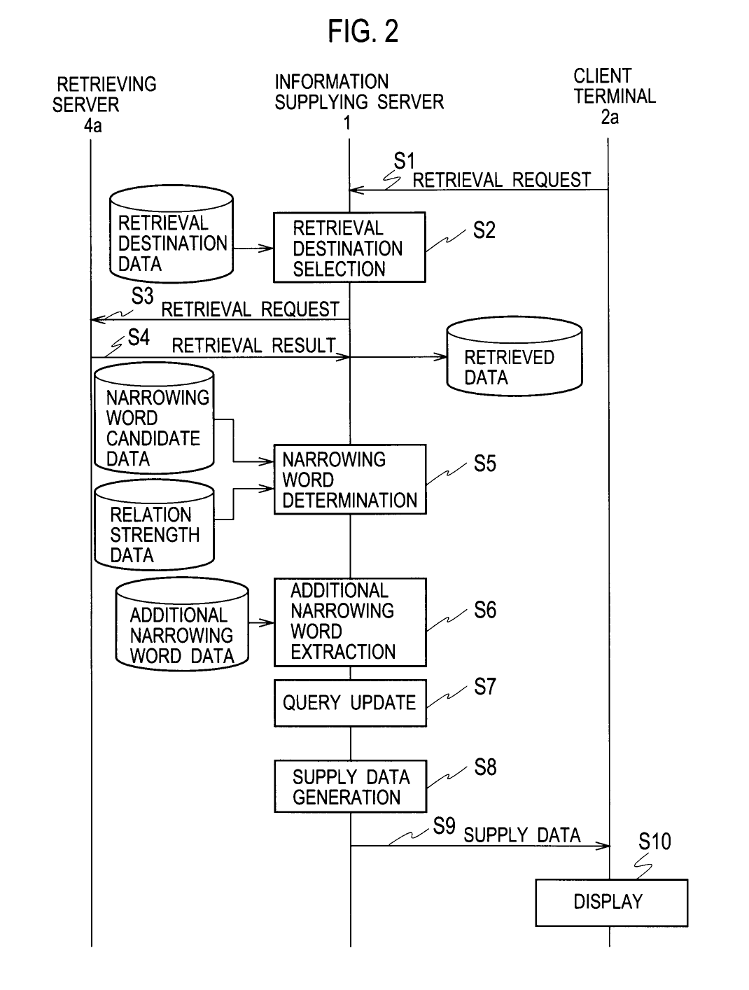

The information supplying server 1 supplies information to e.g. the client terminal 2a by way of an information supplying method, of which processes will be generally described with reference to FIG. 2.

First, at a step S1, the client terminal 2a sends a “request for retrieval” to the information supplying server 1. The “retrieval request” contains a “query” constituted with a “keyword” as a key word of the retrieval. The “retrieval request” may contain a “retrieval method (as an ID of retrieval method)” for retrieval of information relating to the “keyword”.

At a step S2, the information supplying server 1, as it has received the “retrieval request” from the client terminal 2a, operates for reference to data on retrieval destinations to select a “retrieval destination” in accordance with the “keyword” contained in the “retrieval request”.

Next, at a step S3, the information supplying server 1 sends a “request for retrieval” to the retrieval destination selected at the step S2, which is assumed as the retrieval server 4a in this case. This “retrieval request” contains the “keyword” the server 1 has received from the client terminal 2a at the step S1.

Then, at a step S4, the information supplying server 1 receives, from the retrieval server 4a, a set of data as a retrieval result after a retrieval using the “keyword”, which is stored in a memory 11 (FIG. 1).

At a step S5, the information supplying server 1 operates for reference to data on narrowing word candidates and data on relation strength, to extract a “narrowing word” with respect to the “keyword”. The “narrowing word” will be indicated to the user together with data of retrieval result, for guidance to a set of information pieces desirable to the user. The user may select the indicated “narrowing word”, for use of the “narrowing word” to narrow down the retrieval result the server 1 has received from the retrieval server 4a at the step S4, to thereby permit an arrival to a set of more desirable information pieces. It is noted that the selection of “narrowing word” at the step S5 may well be performed in parallel with any one of the steps S2 to S4.

Moreover, at a step S6, the information supplying server 1 operates for reference to data on narrowing word candidates and data on additional narrowing words, to extract an “additional narrowing word” with respect to the “keyword”. The “additional narrowing word” will be indicated to the user together with data of retrieval result, for guidance to a set of information pieces desirable to the user. The user may select the indicated “additional narrowing word”, for use of the “additional narrowing word” to further narrow down a set of data on retrieval result having been once narrowed down by the “narrowing word”, to thereby permit an arrival to a set of still more desirable information pieces. It is noted that the selection of “additional narrowing word” at the step S6 may well be performed in parallel with any one of the steps S2 to S4, as well as with the step S5.

Further, at a step S7, the information supplying server 1 implements a query update process to update a “query”. The “query” to be updated here may be the “query” contained in the retrieval request received at the step S1, or any query else including the “query” contained in the retrieval request and either or both of the “narrowing word” determined at the step S5 and the “additional narrowing word” determined at the step S6. The query update process at the step S7 provides an updated query that may lead to a set of information pieces more desirable to the user.

Thereafter, at a step S8, the information supplying server 1 generates a “set of supply data” on bases of the “retrieved data”, “narrowing word”, “additional narrowing word”, and “updated query”. Then, at a step S9, the information supplying server 1 sends the set of supply data to the client terminal 2a.

At a step S10, the client terminal 2a displays a retrieval result display frame in accordance with the supply data set it has received at the step S9.

(Client Terminals)

Description is now made of the client terminal 2a adapted to request the information supplying server 1 to supply information. The client terminal 2a is assumed as a general information equipment that works by operation of user. For instance, the client terminal 2a may be a personal computer, cellular telephone, HDD recorder, etc. The client terminal 2a may be implemented with typical functions such as those of a CPU, memory, communications controller, display, input-output interface, etc. In the embodiment of FIG. 1, the client terminal 2a is configured with a CPU including a frame display 21 and a retrieval request transmitter 22.

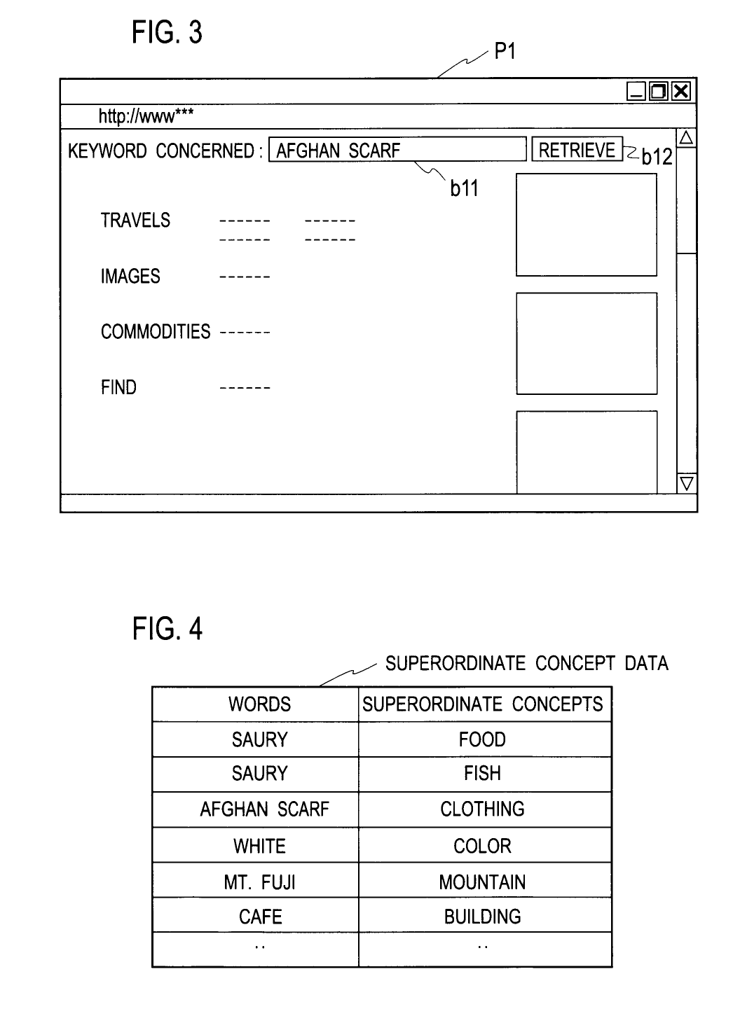

The frame display 21 is configured, as illustrated in FIG. 3, to display on a display device of the client terminal 2a a retrieval frame P1 including a keyword input field b11 for a “keyword” to be input as a retrieval key word for a retrieval of information, and a retrieval execution button b12 operable to enter the retrieval of information.

The retrieval request transmitter 22 is configured to work, by operation of the retrieval execution button b12, for generation of a “retrieval request” containing a keyword input in the keyword input field b11, to transmit it to the information supplying server 1. For instance, in the example of FIG. 3, the retrieval request transmitter 22 is to transmit a retrieval request containing “afghan scarf” as a keyword.

The frame display 21 is adapted, when it has received a “set of supply data” as a result of retrieval from the information supplying server 1, to display on the display device of the client terminal 2a a retrieval result display frame in accordance with the received “set of supply data”.

Like the client terminal 2a above, the client terminals 2b and 2c are each respectively configured with a frame display and a retrieval request transmitter. The communications network 3, connected with the three client terminals 2a, 2b and 2c in the illustration of FIG. 1, may actually have a multiplicity of similar client terminals connected thereto.

(Retrieval Servers)

Description is now made of the retrieval server 4a configured to supply the information supplying server 1 with a result of retrieval in accordance with a retrieval request. The retrieval server 4a is adapted, after reception of a retrieval key word (as a keyword) from the information supplying server 1, to output a set of data encompassing, among others, pieces of information on web pages and commodities matching the retrieval key word. Preferably, respective data to be output from the retrieval server 4a should be described in a structure language such as the XML. More specifically, such pieces of information may preferably be associated with respective items of data output as a result of retrieval, such as title, index, and URL of web page, and URL of image file.

The retrieval server 4b is similar to the retrieval server 4a. The communications network 3, connected with the two servers 4a and 4b for retrieval in the illustration of FIG. 1, may actually have an increased number of retrieval servers connected thereto.

(Information Supplying Server)

Description is now made of the information supplying server 1. This server 1 is configured to retrieve, from the retrieval server 4a or 4b, a set of data as pieces of information matching a “keyword” as a key word for retrieval, to supply them to client terminals such as the 2a. Pieces of information supplied from the information supplying server 1 may encompass, e.g., those of web pages, commodities, and the like relating to the “keyword”. The information supplying server 1, separated from the retrieval servers 4a and 4b in this embodiment, may be integrated with them to constitute a single equipment.

Referring now to FIG. 1, the information supplying server 1 is configured as a typical computer with a CPU (central processing unit) 10, the memory 11, a communications controller 12, and unshown interfaces, storage mediums, etc.

In the information supplying server 1, the memory 11 has files of an unshown information supply program stored therein, which are read for execution by the CPU 10 in the information supplying server 1, to thereby implement a retrieval request receiver 101, a retriever 102, a narrowing word determiner 103, an additional narrowing word extractor 104, a query updater 105, a supply data generator 106, and a supply data transmitter 107.

The memory 11 has a superordinate concept data storer 111, a retrieval destination data storer 112, a retrieved data storer 113, a narrowing word candidate data storer 114, a relation strength data storer 115, an additional narrowing word data storer 116, and a query update data storer 117.

The superordinate concept data storer 111 has stored therein a set of superordinate concept data arrayed as shown in FIG. 4 as an example, for row-wise association of columns of listed “words” with “superordinate concepts” of the words. In the example of superordinate concept data in FIG. 4, there is a word “saury” associated with superordinate concepts “food” and “fish”, and a word “afghan scarf” associated with a superordinate concept “clothing”.

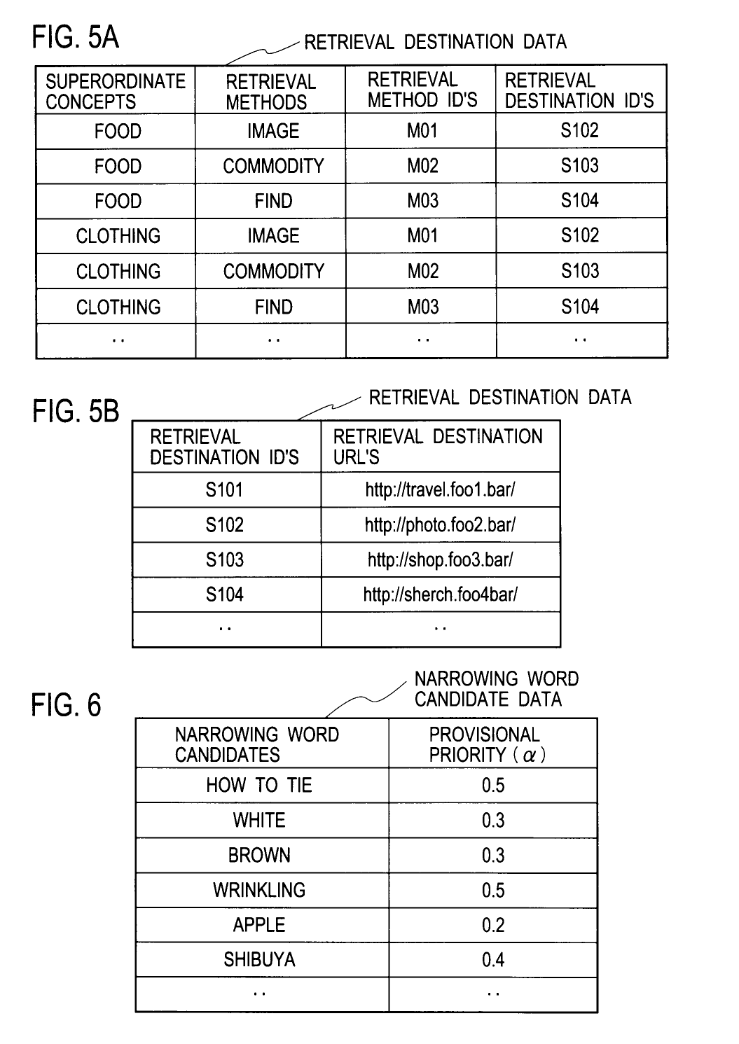

The retrieval destination data storer 112 has stored therein a set of retrieval destination data arrayed as shown in FIG. 5A and FIG. 5B as an example, for row-wise association among columns of “superordinate concepts” of unshown listed words, “retrieval methods” of retrieving relevant data of words associated with the superordinate concepts, “retrieval method ID's” as identifiers of the retrieval methods, and “retrieval destination ID's” associated with the superordinate concepts, as identifiers that identify retrieval servers for supply of data having specific retrieval methods designated therefore. The columns of retrieval destination data may be further associated, by use of the retrieval destination ID's as keys, with a column of communications protocols or program functions employable for retrievals at retrieval destinations.

Each “retrieval destination ID” is an identifier for a retrieval server to be identified therewith as a retrieval destination that is a transmission destination, e.g. the retrieval server 4a, to which a corresponding retrieval request is to be transmitted. For the Internet as the communications network 3, preferably, the “retrieval destination ID” should be an URL.

In the example shown in FIG. 5A and FIG. 5B, the set of retrieval destination data is composed of a first subset of data shown in FIG. 5A for association among columns of “superordinate concepts”, “retrieval methods”, “retrieval method ID's”, and “retrieval destination ID's”, and a second subset of data shown in FIG. 5B for association between columns of “retrieval destination ID's” and “retrieval destination URL's”.

The first subset of data shown in FIG. 5A includes a retrieval destination ID “S102” associated with a combination of a superordinate concept “food”, a retrieval method “image”, and a retrieval method ID “M01”, and a retrieval destination ID “S103” associated with a combination of a superordinate concept “food”, a retrieval method “commodity”, and a retrieval method ID “M02”. In application of this example, for retrieval of the “food” by the “image”, to be accessed is a retrieval server identified by the retrieval destination ID “S102”. For retrieval of the “food” as the “commodity”, to be accessed is a retrieval server identified by the retrieval destination ID “S103”.

The second subset of data shown in FIG. 5B has the column of “retrieval destination ID's” linked with the column of “retrieval destination ID's” in the first subset of data shown in FIG. 5A. The second subset of data includes a retrieval destination ID “S101” associated with a retrieval destination URL “http://travel.foo1.bar/”.

In the example shown in FIG. 5A and FIG. 5B, the set of retrieval destination data is represented by two data tables. It may well be represented by a single data table, or by three or more data tables.

The retrieved data storer 113 has stored therein a set of retrieved data retrieved from the retrieval server 4a or the like by the retriever 102 to be described later on. The retrieved data storer 113 may have stored therein sets of retrieved data retrieved from a plurality of retrieval servers. It is noted that the set of retrieved data is a set of temporary data along a processing of the information supplying server 1, and may stored, not in the memory 11, but in an unshown RAM, to delete as necessary.

The narrowing word candidate data storer 114 has stored therein a set of narrowing word candidate data arrayed as shown in FIG. 6 as an example, for row-wise association between columns of “narrowing word candidates” as candidates of words (narrowing words) for use to narrow down information from the set of retrieved data, and “provisional priorities (α)” representing provisional priorities of the narrowing word candidates. In the example shown in FIG. 6, there is a narrowing word candidate “how to tie” associated with a provisional priority (α) of “0.5”, and a narrowing word candidate “white” associated with a provisional priority (α) of “0.3”.

It is noted that the embodiment described has stored in the memory 11a set of narrowing word candidate data arrayed as shown in FIG. 6, to associate “narrowing word candidates” with “provisional priorities (α)” as preset, while this is not restrictive in any way. For instance, there may be “narrowing word candidates” or “provisional priorities (α)” determined from a history of past processes or received retrieved data. More specifically, there may be use of a history of past processes to determine as a “provisional priority (α)” the frequency of use of a combination of a “keyword” used in the past and a “narrowing word candidate” used together with the “keyword”. Further, there may be use of retrieved data for morpheme analysis of words contained in sentences in retrieval results, to determine as a “provisional priority (α)” the frequency of occurrence of a “keyword”.

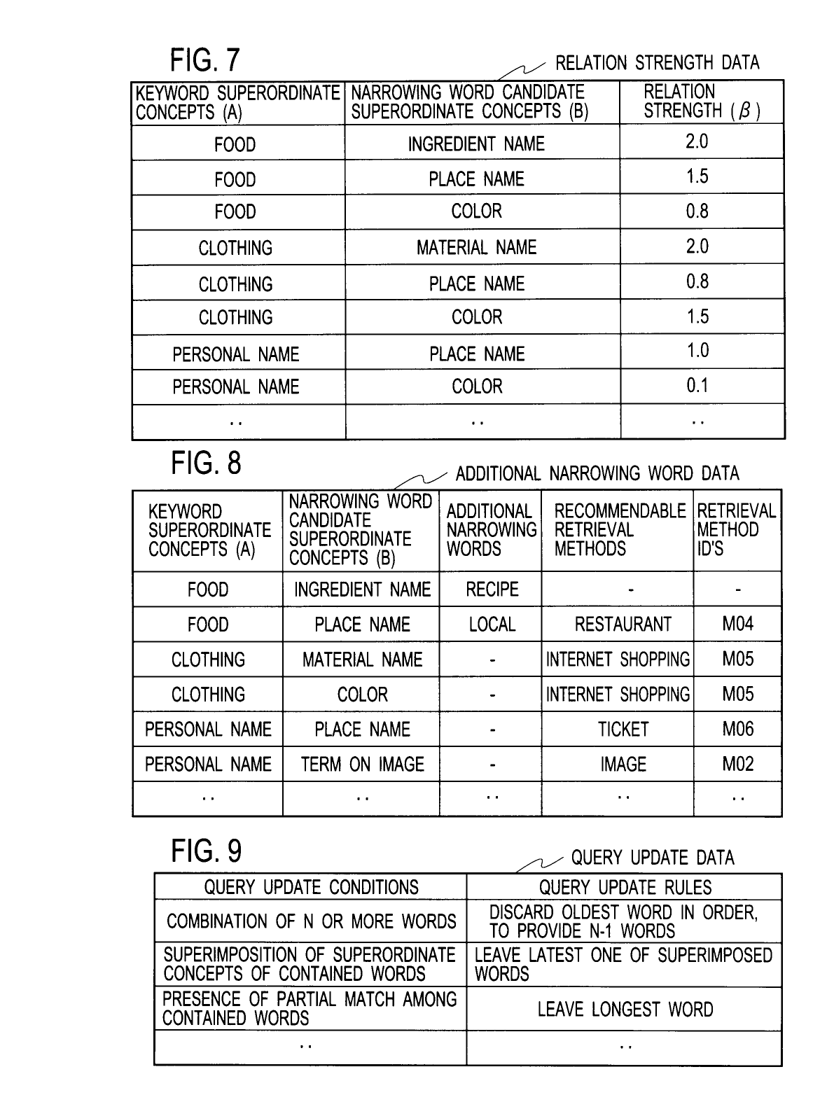

The relation strength data storer 115 has stored therein a set of relation strength data arrayed as shown in FIG. 7 as an example, for row-wise association among columns of “superordinate concepts (A) of keywords”, “superordinate concepts (B) of narrowing word candidates”, and “relation strengths (β)” each representing a degree of relevancy between a superordinate concept (A) of a correspondent keyword and a superordinate concept (B) of a correspondent narrowing word candidate.

In the example shown in FIG. 7, there is a relation strength (β) of “2.0” associated with a combination of a superordinate concept (A) “food” of a keyword and a superordinate concept (B) “ingredient name” of a narrowing word candidate corresponding thereto, and a relation strength (β) of “1.5” associated with a combination of a superordinate concept (A) “food” of the keyword and a superordinate concept (B) “place name” of a narrowing word candidate corresponding thereto. Namely, it is seen that the combination of superordinate concepts “food” and “ingredient name” has a stronger relevancy than the combination of superordinate concepts “food” and “place name”.

The additional narrowing word data storer 116 has stored therein a set of additional narrowing word data arrayed as shown in FIG. 8 as an example, for row-wise association among columns of “superordinate concepts (A) of keywords”, “superordinate concepts (B) of narrowing word candidates”, “additional narrowing words” each to be added in response to a corresponding combination of superordinate concept (A) and superordinate concept (B), “recommendable retrieval methods” each recommendable as a retrieval method for use by user in response to a corresponding combination of superordinate concept (A) and superordinate concept (B), and “retrieval method ID's” for identification of the recommendable retrieval methods. It is noted that the embodiment described has “additional narrowing words” and “recommendable retrieval methods” associated with each other in the set of additional narrowing word data, while “additional narrowing words” and “recommendable retrieval methods” may be separately stored in two data tables associated with each other.

In the example shown in FIG. 8, there is a combination of a superordinate concept (A) “food” of a keyword and a superordinate concept (B) “ingredient name” of a narrowing word candidate corresponding thereto associated with an additional narrowing word “recipe”, and a combination of a superordinate concept (A) “food” of the keyword and a superordinate concept (B) “place name” of a narrowing word candidate corresponding thereto associated with an additional narrowing word “local” and with a recommendable retrieval method “restaurant”.

The query update data storer 117 has stored therein a set of query update data arrayed as shown in FIG. 9 as an example, for row-wise association between columns of “query update conditions” each employable to determine whether or not a query update is requisite, and “query update rules” each as a rule to update a corresponding query.

In the example shown in FIG. 9, there is a condition for a query as a “combination of N or more words” associated with a rule to “discard the oldest word to provide a combination of N−1 words” as an updated query. As described with reference to FIG. 2, any “query” may be updated to a new query by addition of a “keyword” designated by a retrieval request, as well as “narrowing word”, “additional narrowing word”, or the like. This way of update may be repeated a plurality of times, so such repetition of update may provide a query composed of many words (keywords, narrowing words, and additional narrowing words). The larger the number of words contained in a query gets, the narrower the range of retrieval of data becomes, with an increasing difficulty to use an updated query for retrieval of desirable information. In view of this issue, if the number of words contained in a current query is equal to or greater than a preset number (N), this query is updated into a new query composed of N−1 words by deleting in order a word (keyword, narrowing word, or additional narrowing word) that has been contained since the oldest update in the course of query update. More specifically, assuming N=3, if a current query is composed of words “curry”, “blog”, and “image” (in the chronological order), the oldest word “curry” is to be discarded to provide an updated new query composed of words “blog” and “image”.

Moreover, there is a condition for a query “containing words having superimposed superordinate concepts” associated with a rule to “leave the latest one of superimposed words” in an updated query. In this case, if a current query contains words (keyword(s), narrowing word(s), and/or additional narrowing word(s)) that have superordinate concepts superimposed on each other, this query is updated by deleting in order one of the words having superimposed superordinate concepts that has been contained since the oldest update in the course of query update, to thereby provide an updated new query as a query desirable to the user. More specifically, if a current query is composed of words “Yokohama”, “curry”, and “Kamakura” (in the chronological order) in which the words “Yokohama” and “Kamakura” have superimposed place names as their superordinate concepts, the latest word “Kamakura” in between is left to provide an updated new query composed of words “curry” and “Kamakura”.

Further, there is a condition for a query “containing words matching each other in part” associated with a rule to “leave the longest word” in an updated query. More specifically, if a current query is composed of words “Yokohama Station”, “curry”, and “Yokohama” in which the words “Yokohama Station” and “Yokohama” match each other in part, the longest word “Yokohama Station” is left to provide an updated new query composed of words “Yokohama Station” and “curry”.

The retrieval request receiver 101 is adapted, after reception of a “retrieval request” from a client terminal such as the 2a, to extract from a set of superordinate concept data a “superordinate concept (A)” of a “keyword” contained in the “retrieval request”, to output to the retriever 102, narrowing word determiner 103, and additional narrowing word extractor 104. Further, the retrieval request receiver 101 is adapted to output to the retriever 102 a “query (keyword)” contained in the “retrieval request”.

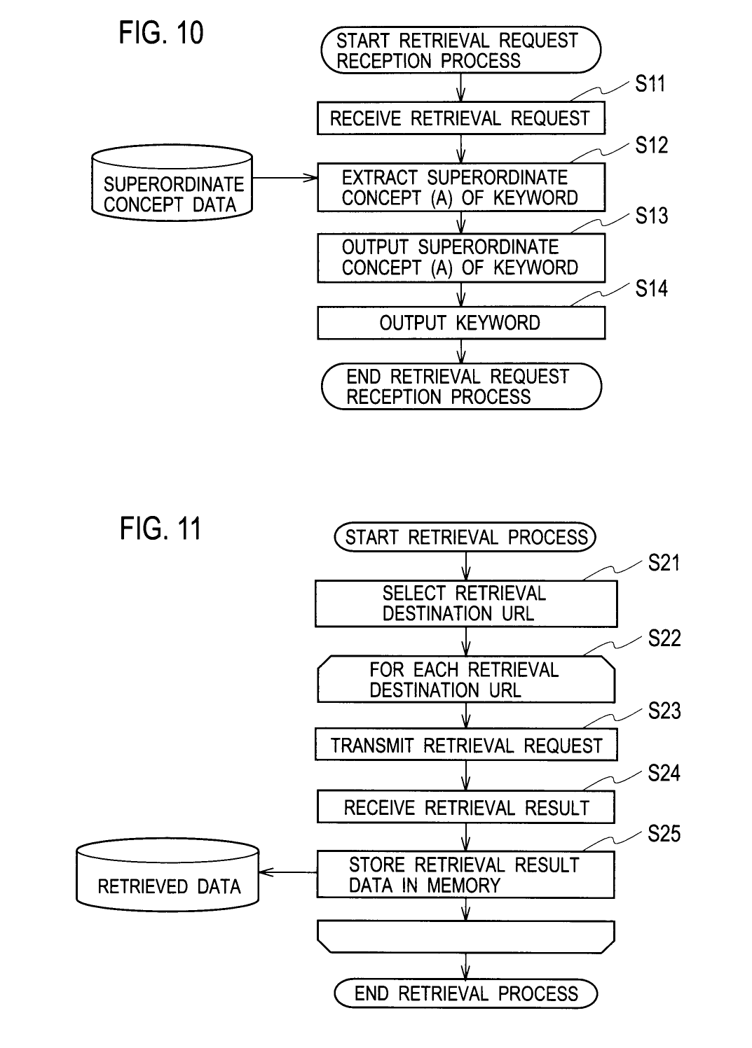

Description is now made of a retrieval request reception process at the retrieval request receiver 101, with reference to a flowchart in FIG. 10 and superordinate concept data in FIG. 4.

First, at a step S11, the retrieval request receiver 101 receives a “retrieval request” from a client terminal such as the 2a, and stores the received “retrieval request” in a memory (not shown). The “retrieval request” contains a “query” comprising a “keyword”, e.g. “afghan scarf”, for use in a retrieval of information wanted by a user of the client terminal, e.g., 2a. The “query” may be composed of a single keyword, or a plurality of keywords.

Then, at a step S12, the retrieval request receiver 101 extracts, from a set of superordinate concept data stored in the superordinate concept data storer 111, a “superordinate concept” associated with the “keyword” contained in the “retrieval request” received at the step S11, and stores it as a superordinate concept (A) of the keyword in memory. If the “keyword” of concern is “afghan scarf”, the retrieval request receiver 101 extracts a word “clothing” from the set of superordinate concept data.

Thereafter, at a step S13, the retrieval request receiver 101 outputs the superordinate concept (A) of keyword extracted at the step S12, to the retriever 102, narrowing word determiner 103, and additional narrowing word extractor 104.

Further, at a step S14, the retrieval request receiver 101 outputs to the retriever 102 the “query (keyword)” contained in the “retrieval request” received at the step S11. If the “retrieval request” contains a “retrieval method” (e.g. “commodity”) besides the “keyword” (e.g. “afghan scarf”), the retrieval request receiver 101 outputs the “retrieval method” as well as the “keyword” to the retriever 102.

It is noted that in the embodiment described the retrieval request receiver 101 outputs the superordinate concept (A) of keyword extracted to the retriever 102, narrowing word determiner 103, and additional narrowing word extractor 104, while the retrieval request receiver 101 may simply output the “keyword”. In this case, the retriever 102, narrowing word determiner 103, or additional narrowing word extractor 104 may read a set of superordinate concept data, to extract therefrom a “superordinate concept (A)” to be used.

The retriever 102 is adapted, with the “superordinate concept (A)” input thereto as well as the “keyword” input from the retrieval request receiver 101, to extract a “retrieval destination URL” associated with the “superordinate concept” as it is input from the set of retrieval destination data. If the “retrieval method” is input together with the “superordinate concept”, the retriever 102 is adapted to extract a “retrieval destination URL” associated with the input “superordinate concept” and “retrieval method”. Further, the retriever 102 is adapted to transmit a “retrieval request” containing a “query” constituted with the input “keyword”, to a retrieval server corresponding to the extracted “retrieval destination URL”, and receive a result of retrieval transmitted from the retrieval server, to store as a retrieved data in the retrieved data storer 113. If the retriever 102 has extracted a plurality of “retrieval destination URL's”, it is adapted to transmit the “keyword” to all the input retrieval destination URL's, to have retrievals performed at respective retrieval servers, and receive a “retrieved data” from each retrieval server.

Description is now made of a retrieval process at the retriever 102, with reference to a flowchart in FIG. 11.

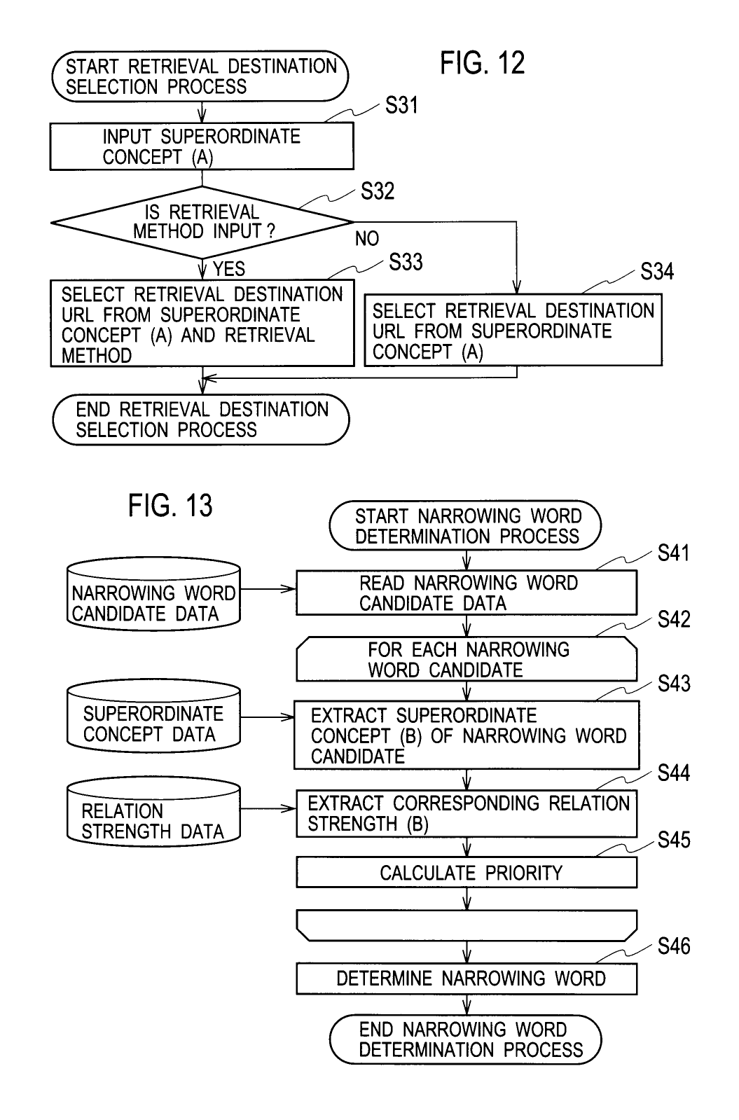

First, at a step S21, the retriever 102 has a “superordinate concept” input thereto from the retrieval request receiver 101, to select a retrieval destination. This selection of retrieval destination will be described later on, with reference to FIG. 12.

Thereafter, at steps S22 and S23, the retriever 102 generates a “retrieval request” containing the input “keyword”, to transmit to a retrieval server identified by a “retrieval destination URL” selected at the step S21.

Further, at a step S24, the retriever 102 receives a “retrieval result” from the retrieval server having transmitted the “retrieval request”. And, at a step S25, the retriever 102 stores the “retrieval result” as a retrieved data in the retrieved data storer 113.

Then, at the step S22, the retriever 102 executes a combination of processes at the steps S23 to S25 for each of retrieval servers identified by “retrieval destination URL's” selected at the step S21.

The received “retrieval result” is a set of data as pieces of information each described in a structure language such as the XML associated therewith, by items of output retrieval result, such as title, index, and URL of web page, and URL of image file.

It is noted that the retrieval destination data storer 112 may have a set of retrieval destination data associated with communications protocols or program functions employable for retrievals at retrieval destinations. In such a case, the retriever 102 may be adapted to transmit a “keyword” to a retrieval destination URL in accordance with an associated communications protocol or program function.

Description is now made of a retrieval destination selection process at the step S21, with reference to a flowchart in FIG. 12 and retrieval destination data in FIG. 5A and FIG. 5B.

First, at a step S31, the retriever 102 has a “superordiante concept” input thereto from the retrieval request receiver 101. Then, at a step S32, it is determined whether or not a “retrieval method” is input together with the “superordiante concept”.

If both “superordiante concept” and “retrieval method” are input (Yes at the step S32), the retriever 102 extracts a “retrieval destination URL” associated with the input “superordiante concept” and “retrieval method”, and goes to a step S33, where it determines the “retrieval destination URL” to be a retrieval destination of information on the “keyword”.

For instance, if a combination of a superordinate concept “clothing” and a retrieval method “commodity” is input, then the retriever 102 extracts from the set of retrieval destination data a retrieval destination URL “http://shop.foo3.bar/” associated with a retrieval destination ID “S103”, as a retrieval destination relating to the combination of “clothing” and “commodity”.

On the other hand, if simply the “superordiante concept” is input (No at the step S32), the retriever 102 extracts a “retrieval destination URL” associated with the input “superordiante concept”, and goes to a step S34, where it determines the “retrieval destination URL” to be a retrieval destination of information on the “keyword”. For instance, if a superordinate concept “clothing” is input, then the retriever 102 extracts from the set of retrieval destination data a retrieval destination URL “http://photo.foo2.bar/” associated with a retrieval destination ID “S102”, the retrieval destination URL “http://shop.foo3.bar/” associated with the retrieval destination ID “S103”, and a retrieval destination URL “http://search.foo4.bar/” associated with a retrieval destination ID “S104”, as retrieval destinations relating to the “clothing”.

The narrowing word determiner 103 is adapted, with a “superordinate concept (A)” of keyword input from the retrieval request receiver 101, to determine a “priority” from a column of “provisional priorities (α)” defined to narrowing word candidates listed in a set of narrowing word candidate data, and a “relation strength (β)” defined to a combination of the “superordinate concept (A)” of keyword and a “superordinate concept (B)” of narrowing word candidate. The narrowing word determiner 103 is further adapted for use of the “priority” to determine a “narrowing word”, to output to the supply data generator 106.

Description is now made of a narrowing word determination process at the narrowing word determiner 103, with reference to a flowchart in FIG. 13, narrowing word candidate data in FIG. 7, and relation strength data in FIG. 7.

First, at a step S41, with a “superordinate concept (A)” of keyword input from the retrieval request receiver 101, the narrowing word determiner 103 reads a set of narrowing word candidate data from the narrowing word candidate data storer 114, to store in memory.

Thereafter, at steps S42 and S43, for a narrowing word candidate as a current target in a set of narrowing word candidate data, the narrowing word determiner 103 extracts a “superordinate concept (B)” of the narrowing word candidate from a set of superordinate concept data stored in the superordinate concept data storer 111. For instance, for a narrowing word candidate “white” as a current target, the narrowing word determiner 103 extracts a superordinate concept “color” of “white” from the set of superordinate concept data.

Further, at a step S44, the narrowing word determiner 103 extracts, from a set of relation strength data stored in the relation strength data storer 115, a “relation strength (β)”, associated with a combination of the “superordinate concept (A)” of keyword input from the retrieval request receiver 101 and the “superordinate concept (B)” of narrowing word candidate extracted at the step S43. For instance, if the input superordinate concept (A) is “clothing” and the extracted superordinate concept (B) is “color”, then the narrowing word determiner 103 extracts from the set of relation strength data a relation strength (β) of “1.5” associated with the combination of “clothing” and “color”.

Subsequently, at a step S45, the narrowing word determiner 103 determines a “priority” in accordance with a combination of a “provisional priority (α)” associated with the “narrowing word candidate” as the current target in the set of narrowing word candidate data and the “relation strength (β)” extracted at the step S44, and stores it in memory, associating with the “narrowing word candidate”. The priority may be determined by α×β. An example will be explained. For a narrowing word candidate “white” of which the provisional priority (α) is “0.3”, if the relation strength (β) extracted at the step S44 is “1.5”, then the narrowing word determiner 103 determines the “priority” to be “0.45 (=0.3×1.5)”.

For every narrowing word candidate in the set of narrowing word candidate data, the processes at the steps S42 to S45 are to be completed at the step S41. Then, at a step S46, the narrowing word determiner 103 follows a prescribed rule for use of resultant “priorities” to determine a set of “narrowing words”. For instance, there may be a set of “narrowing words” determined as a set of “narrowing word candidates” having “priorities” over a prescribed value (e.g. “0.8”), or a set of “narrowing words” determined as a series of “narrowing word candidates” sorted in a descending order of “priority” and taken as a prescribed number of (e.g. “3”) “narrowing words” as counted the highest order.

The additional narrowing word extractor 104 is adapted, with a “superordinate concept (A)” of keyword input from the retrieval request receiver 101, to extract, for a respective narrowing word candidate listed in a set of narrowing word candidate data, an “additional narrowing word” associated with a combination of a “superordinate concept (A)” of keyword and a “superordinate concept (B)” of narrowing word candidate. Moreover, the additional narrowing word extractor 104 is adapted to extract a “recommendable retrieval method” associated with the combination of “superordinate concept (A)” and “superordinate concept (B)”. Further, the additional narrowing word extractor 104 is adapted to output the extracted “additional narrowing word” and “recommendable retrieval method” to the supply data generator 106.

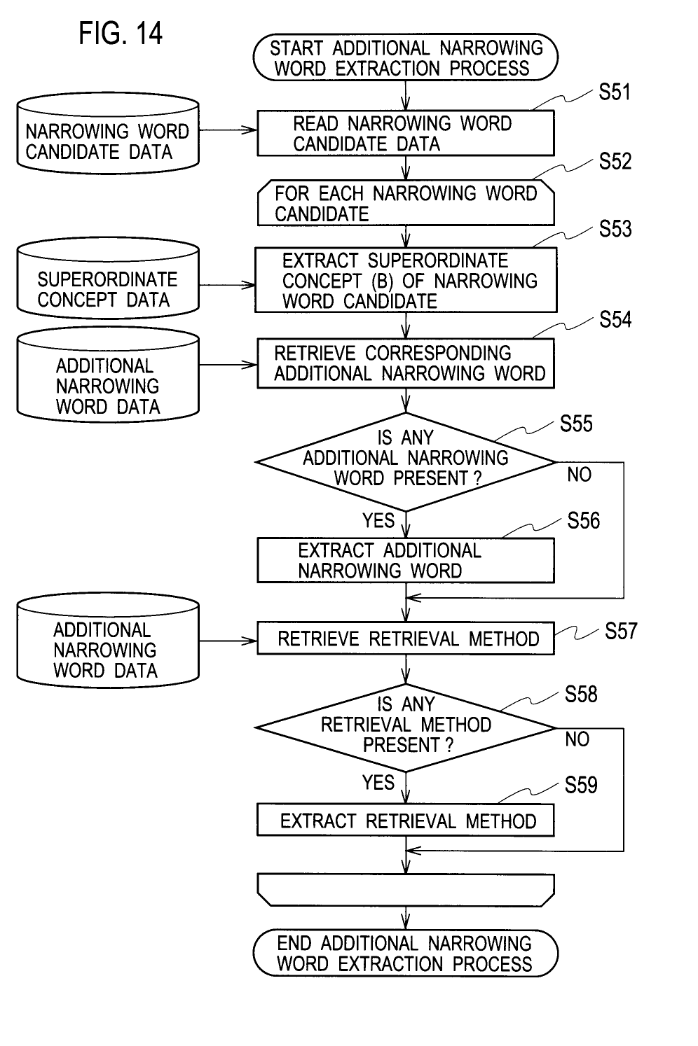

Description is now made of an additional narrowing word extraction process at the additional narrowing word extractor 104, with reference to a flowchart in FIG. 14, and additional narrowing word data in FIG. 7.

First, at a step S51, with a “superordinate concept (A)” of keyword input from the retrieval request receiver 101, the additional narrowing word extractor 104 reads a set of narrowing word candidate data from the narrowing word candidate data storer 114, to store in memory.

Thereafter, at steps S52 and S53, for a narrowing word candidate as a current target in a set of additional narrowing word data, the additional narrowing word extractor 104 extracts a “superordinate concept (B)” of the narrowing word candidate from a set of superordinate concept data stored in the superordinate concept data storer 111. For instance, for a narrowing word candidate “saury” as a current target, the additional narrowing word extractor 104 extracts superordinate concepts “food” and “fish” of “saury” from the set of superordinate concept data.

Subsequently, at a step S54, the additional narrowing word extractor 104 retrieves, from a set of additional narrowing word data stored in the additional narrowing word data storer 116, an “additional narrowing word” associated with a combination of a “superordinate concept (A)” of keyword input from the retrieval request receiver 101 and a “superordinate concept (B)” of narrowing word candidate extracted at the step S53, and if any corresponding “additional narrowing word” is found (Yes at a step S55), goes to a step S56, where it extracts the “additional narrowing word”.

For instance, if the superordinate concept (A) is “food” and the superordinate concept (B) is “ingredient name”, then the additional narrowing word extractor 104 extracts an additional narrowing word “recipe”, and goes to a subsequent step. On the other hand, if the superordinate concept (A) is “clothing” and the superordinate concept (B) is “material name”, then as the set of additional narrowing word data has no corresponding additional narrowing words, the additional narrowing word extractor 104 directly goes to the subsequent step, without extraction of additional narrowing word.

Moreover, at a step S57, the additional narrowing word extractor 104 retrieves, from the set of additional narrowing word data, a “recommendable retrieval method” associated with the combination of “superordinate concept (A)” of keyword input from the retrieval request receiver 101 and “superordinate concept (B)” of narrowing word candidate extracted at the step S53, and if any corresponding “recommendable retrieval method” is found (Yes at a step S58), goes to a step S59, where it extracts the recommendable retrieval method as a “retrieval method”.

For instance, if the superordinate concept (A) is “food” and the superordinate concept (B) is “material name”, then as the set of additional narrowing word data has no corresponding “recommendable retrieval method”, the additional narrowing word extractor 104 directly goes to a subsequent step, without extraction of recommendable retrieval method. On the other hand, if the superordinate concept (A) is “clothing” and the superordinate concept (B) is “material name”, then the additional narrowing word extractor 104 extracts a recommendable retrieval method “net shopping”, and goes to the subsequent step.

The query updater 105 is adapted, with a “query (keyword)” input from the retrieval request receiver 101, a “narrowing word” input from the narrowing word determiner 103, and an “additional narrowing word” input from the additional narrowing word extractor 104, to make use of a set of query update data to update the query as a retrieval style composed of synthesized input words. The query updater 105 is adapted to output an updated new query to the supply data generator 106.

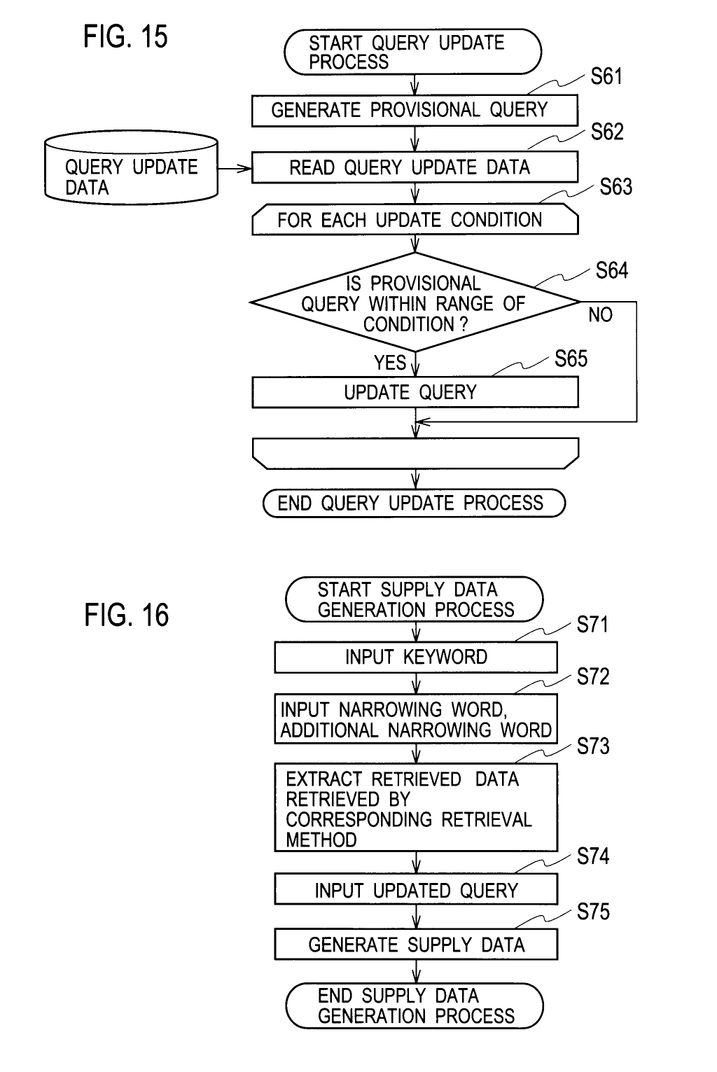

Description is now made of a query update process at the query updater 105, with reference to a flowchart in FIG. 15, and query update data in FIG. 9.

First, at a step S61, the query updater 105 synthesizes a “query” input from the retrieval request receiver 101, a “narrowing word” input from the narrowing word determiner 103, and an “additional narrowing word” input from the additional narrowing word extractor 104, to generate a candidate for new query, and stores it as a provisional query in memory. Then, at a step S62, the query updater 105 read a set of query update data from the query update data storer 117, to store in memory.

For instance, there may be input a query “curry and rice”, narrowing words “apple” and “Shibuya”, and additional narrowing words “recipe” and “local”. Then, the query updater 105 synthesizes “curry and rice”, “apple”, “Shibuya”, “recipe”, and “local” to provide a candidate for query.

Thereafter, at steps S63 and S64, the query updater 105 operates, for an update condition in the set of query update data as a current target, to determine whether or not the query candidate generated at the step S62 is compliant with that update condition. If the query candidate is compliant with the update condition as the current target (Yes at the step S64), the query updater 105 goes to a step S65, where it updates the query candidate, to store a new query in memory.

For instance, if a query candidate input is “afghan scarf, while, brown”, then as an update condition “superimposition of superordinate concepts of contained words” is met, the query updater 105 deletes “white”, storing “afghan scarf, brown” as a new query in memory.

After the new query is stored in memory at the step S65, or (No at the step S64, i.e.) unless the synthesized query is compliant with the update condition as the current target at the step S64, the query updater 105 goes to the step S63, where it operates for another update condition as a target to repeat processes at the steps S64 and S65.

The supply data generator 106 is adapted, with a “keyword” input from the retrieval request receiver 101, a “narrowing word” input from the narrowing word determiner 103, an “additional narrowing word” input from the additional narrowing word extractor 104, and a “new query” input from the query updater 105, to generate a supply data on bases of the input “narrowing word”, “additional narrowing word”, and “new query”, and “retrieved data”, and output it to the supply data transmitter 107.

Description is now made of a supply data generation process at the supply data generator 106, with reference to a flowchart in FIG. 16.

First, at a step S71, the supply data generator 106 has a “keyword” input from the retrieval request receiver 101, and at a step S72, it has a “narrowing word” input from the narrowing word determiner 103, and an “additional narrowing word” input from the additional narrowing word extractor 104.

Then, at a step S73, the supply data generator 106 reads a “set of retrieved data” stored in the retrieved data storer 113, and at a step S74, it has a “new query” input from the query updater 105.

Thereafter, at a step S75, the supply data generator 106 synthesizes the “new query” with the “set of retrieved data” to generate a “supply data”, and outputs this to the supply data transmitter 107.

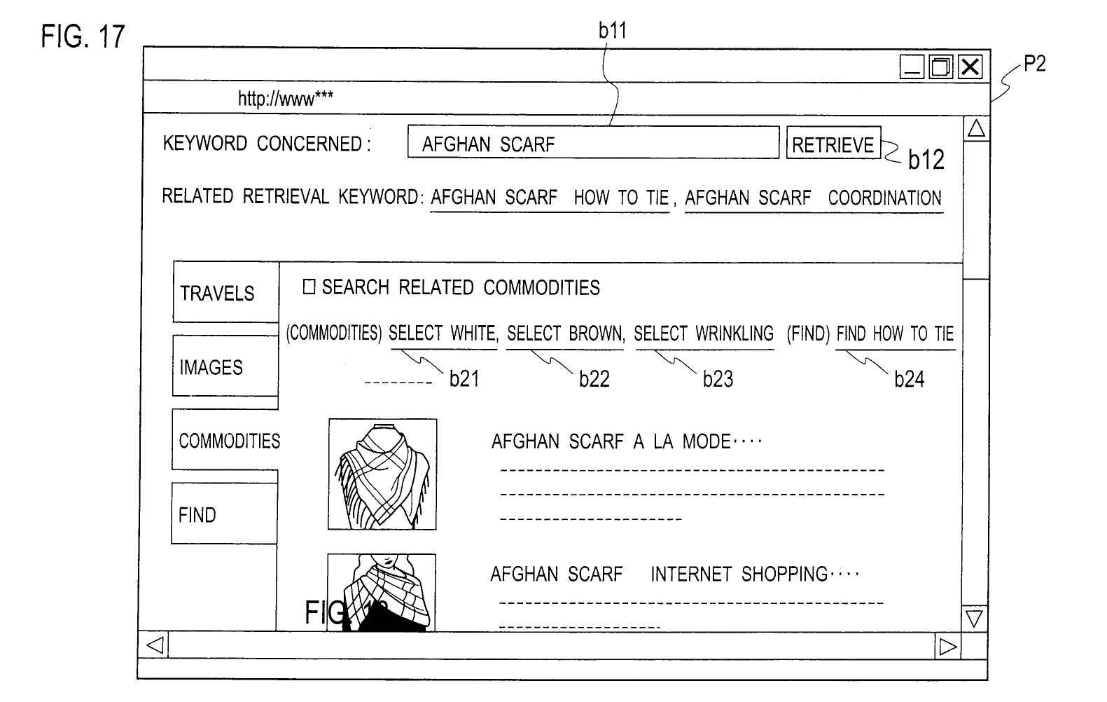

The supply data transmitter 107 is adapted to transmit “supply data” generated at the supply data generator 106, to a respective client terminal, such as the 2a, that has transmitted a “retrieval request” to the retrieval request receiver 101. At the client terminal, as the supply data is received, a display device is operated thereon to display such a retrieval result display frame as illustrated FIG. 17 through FIG. 19.

FIG. 17 illustrates a retrieval result display frame P2 as an example indicating a key word input field b11 and a retrieval execution button b12, as well as some narrowing words b21 to b24.

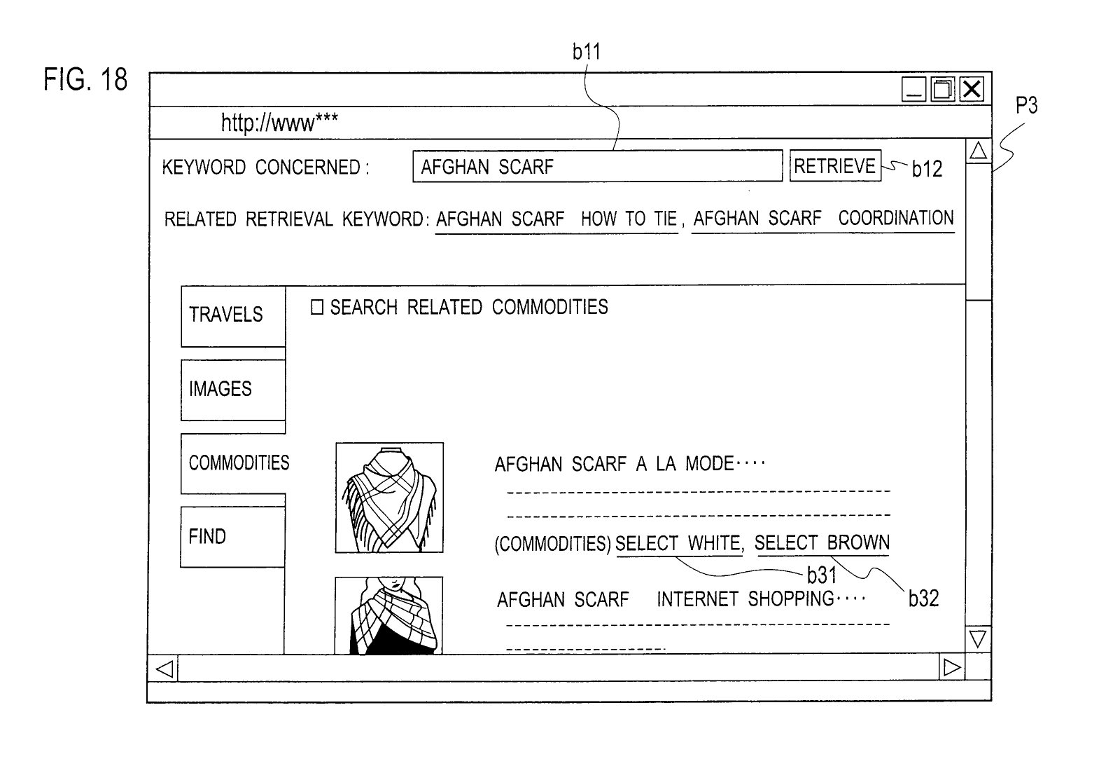

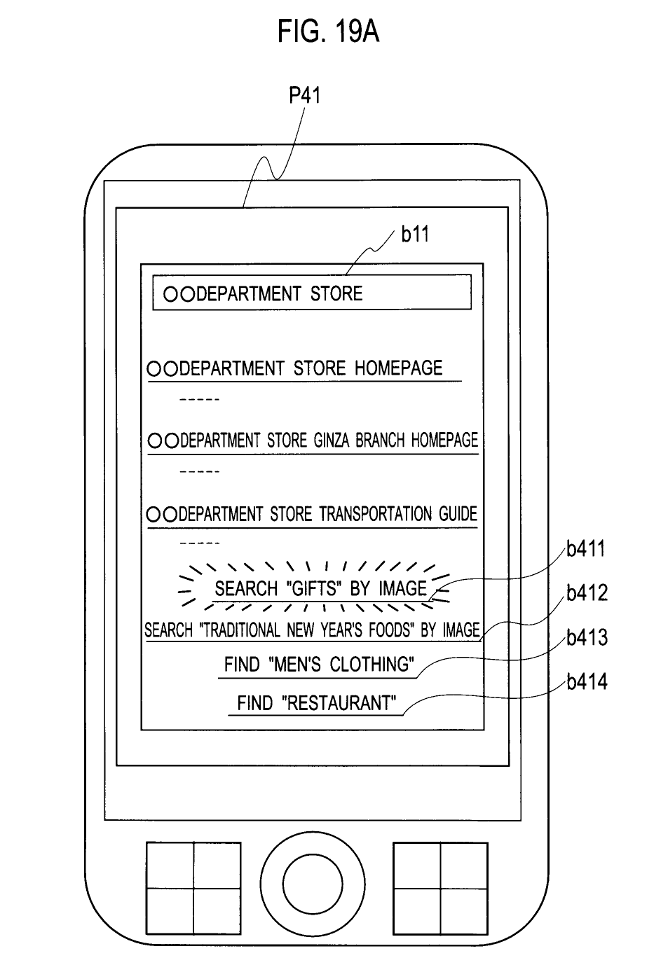

Likewise, FIG. 18 illustrates a retrieval result display frame P3 as an example indicating a key word input field b11 and a retrieval execution button b12, as well as some narrowing words b31 and b32.

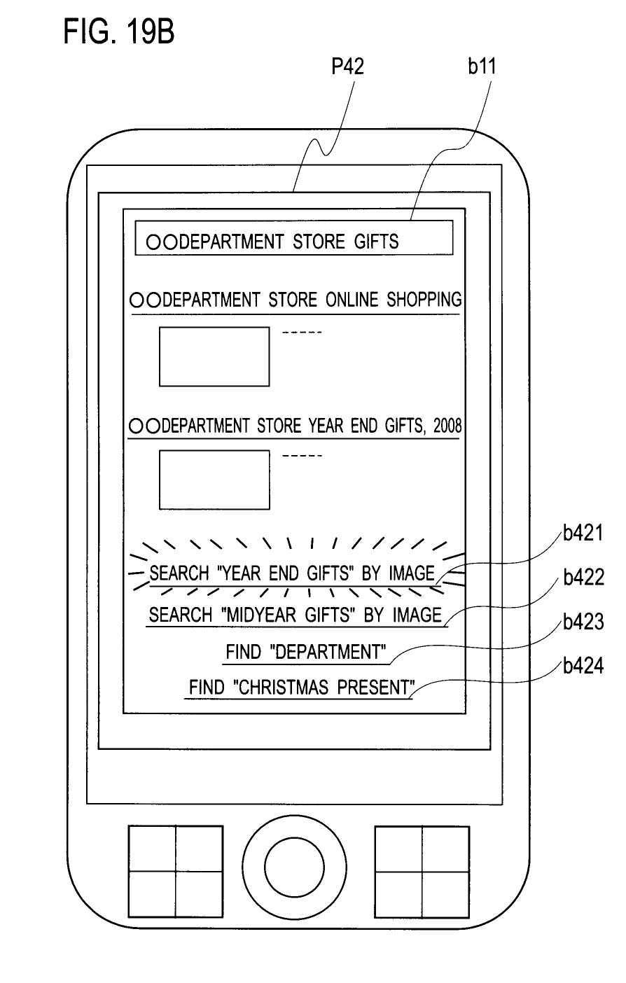

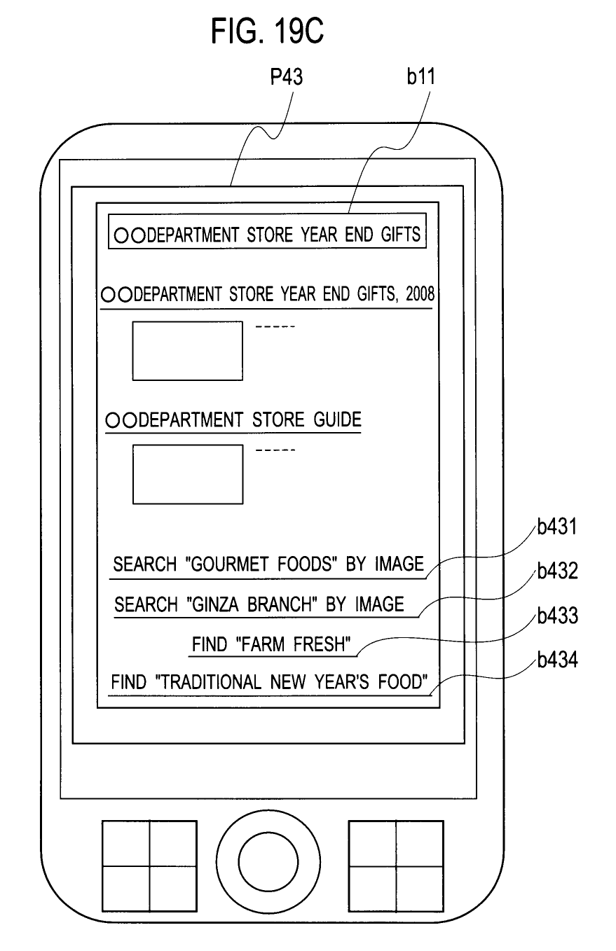

FIG. 19 is a combination of three figures FIG. 19A, FIG. 19B, and FIG. 19C illustrating retrieval result display frames P41 to P43 as examples indicating key word input fields b11 and arrays of updated new queries b411 to b414, b421 to b424, and b431 to b434, respectively. As will be seen from FIG. 19A, the retrieval result display frame P41 is displayed in response to a key word “◯◯ department store” input to the key word input field b11. This retrieval result display frame P41 covers a set of retrieved data including a link to a “◯◯ department store homepage”, a link to a “◯◯ department store Ginza branch homepage”, and a link to a “◯◯ department store transportation guide”, in addition to a query b411 “search ‘gifts’ by image”, a query b412 “search ‘traditional new year's foods’ by image” (N.B. foods are sold in Japanese department stores), a query b413 “find ‘men's clothing”, and a query b414 “find ‘restaurant” (N.B. restaurants are open in Japanese department stores) each employable to narrow down pieces of information on department store.

The retrieval result display frame P41 (FIG. 19A) is changed by selection of the query b411 “search ‘gifts’ by image”, to the retrieval result display frame P42 (FIG. 19B) indicating a result of retrieval of gift images. This retrieval result display frame P42 covers a set of retrieved data associated with a combination of “◯◯ department store” and “gift” input to the key word input field b11, including a link to “a webpage of ◯◯ department store online shopping” and a link to “◯◯ department store year end gifts (N.B. a sort of Japanese gifts), 2008”, in addition to a query b421 “search ‘year end gifts’ by image”, a query b422 “search ‘midyear gifts (N.B. a sort of Japanese gifts)’ by image”, a query b423 “find ‘department’”, and a query b424 “find ‘Christmas present’” each employable to narrow down pieces of information.

Further, the retrieval result display frame P42 (FIG. 19B) is changed by selection of the query b421 “search ‘year end gifts’ by image”, to the retrieval result display frame P43 (FIG. 19C) indicating a result of retrieval of year end gift images. This retrieval result display frame P43 covers a set of retrieved data associated with a combination of “◯◯ department store” and “year end gift” input to the key word input field b11, including a link to “a webpage of ◯◯ department store year end gifts, 2008” and a link to “a webpage of ◯◯ department guide”, in addition to a query b431 “search ‘gourmet foods’ by image”, a query b432 “search ‘Ginza branch’ by image”, a query b433 “find ‘farm fresh’”, and a query b434 “find ‘traditional new year's food’” each employable to narrow down pieces of information.

According to the embodiment above, an information supplying server is configured for a retrieval under conditions of retrieval keyword and retrieval method, permitting a result to be displayed together with a narrowing word, additional narrowing word, etc as illustrated in FIG. 17 through FIG. 19, allowing for presentation to user in a structured style.

According to embodiment of the present invention, an information supplying server is adapted to present a desirable narrowing word to user in accordance with a combination of provisional priority and relation strength. Moreover, it affords to present a desirable range of additional narrowing words and retrieval methods to user, even with much information to be retrieved. Further, it permits a desirable retrieval to user, including removal of inefficient words from a set of words employable for retrieval and refinement, without over-refinement of information for retrieval.

There have been described embodiments of the present invention for illustrative purposes, and description and drawings constituting part of the disclosure should not be construed as restrictive. With the disclosure, artisan might conceive various embodiments, modifications, or techniques for practice.

For instance, according an embodiment of the present invention, an information supplying server may be configured on a single hardware unit, as shown in FIG. 1, or on a plurality of hardware units in consideration of the numbers of functions and processes.

The present invention may well cover various embodiments and modifications, as well as a range of techniques to be construed within the scope of appended claims.

What is claimed is:

1. An information supplying server configured to retrieve information matching a query composed of a keyword as a retrieval key word, to supply to a client terminal, the information supplying server comprising:
a retrieval destination data storer configured for storage of retrieval destination data for association of superordinate concepts of keywords, and retrieval destination identifiers for identification of retrieval servers adapted to supply information retrieved by a keyword of superordinate concept;
a retrieval request receiver configured to receive a query containing a keyword from the client terminal;
a retriever configured to transmit a received query to a retrieval server identified by a retrieval destination identifier associated with a superordinate concept of a received keyword in the retrieval destination data, and receive retrieved data from the retrieval server;
a narrowing word determiner configured to determine a narrowing word in accordance with a priority determined from a provisional priority set to a narrowing word candidate as a candidate of narrowing word for use to narrow down information from retrieved data, and a degree of relevancy set to a superordinate concept of narrowing word candidate and the superordinate concept of keyword; and
a supply data transmitter configured to transmit to the client terminal a supply data as a synthesis of the retrieved data with a new query having a determined narrowing word combined with the received query.

2. The information supplying server according to claim 1, comprising:
an additional narrowing word data storer configured for storage of additional narrowing word data for association of superordinate concepts of keywords, superordinate concepts of narrowing words, and additional narrowing words for use to narrow down information from retrieved data retrieved by keyword and narrowing word; and
an additional narrowing word extractor configured for extraction of an additional narrowing word associated with a superordinate concept of keyword and a superordinate concept of narrowing word, wherein
the supply data transmitter is adapted for transmission of a supply data with the new query containing the additional narrowing word.

3. An information supplying server configured to retrieve information matching a query composed of a keyword as a retrieval key word, to supply to a client terminal, the information supplying server comprising:
a retrieval destination data storer configured for storage of retrieval destination data for association of superordinate concepts of keywords, and retrieval destination identifiers for identification of retrieval servers adapted to supply information retrieved by a keyword of superordinate concept;
a retrieval request receiver configured to receive from the client terminal a query containing a keyword and a narrowing word for use to narrow down information from retrieved data;
a retriever configured to transmit a received keyword to a retrieval server identified by a retrieval destination identifier associated with a superordinate concept of the received keyword in the retrieval destination data, and receive retrieved data from the retrieval server;
an additional narrowing word data storer configured for storage of additional narrowing word data for association of superordinate concepts of keywords, superordinate concepts of narrowing words, and additional narrowing words for use to narrow down information from retrieved data retrieved by keyword and narrowing word;
an additional narrowing word extractor configured for extraction of an additional narrowing word associated with a superordinate concept of keyword and a superordinate concept of narrowing word; and,
a supply data transmitter configured to transmit to the client terminal a supply data as a synthesis of the retrieved data with a new query having a determined narrowing word combined with the received query.

4. The information supplying server according to claim 2, wherein
the additional narrowing word data associates a superordinate concept of keyword and a superordinate concept of narrowing word, with a recommendable retrieval method as a retrieval method recommendable for use to the superordinate concept of keyword and the superordinate concept of narrowing word,
the additional narrowing word extractor is adapted to extract a recommendable retrieval method associated with a superordinate concept of keyword and a superordinate concept of narrowing word, and
the supply data transmitter is adapted to transmit a supply data containing the extracted recommendable retrieval method.

5. The information supplying server according to claim 3, wherein
the additional narrowing word data associates a superordinate concept of keyword and a superordinate concept of narrowing word, with a recommendable retrieval method as a retrieval method recommendable for use to the superordinate concept of keyword and the superordinate concept of narrowing word,
the additional narrowing word extractor is adapted to extract a recommendable retrieval method associated with a superordinate concept of keyword and a superordinate concept of narrowing word, and
the supply data transmitter is adapted to transmit a supply data containing the extracted recommendable retrieval method.

6. The information supplying server according to claim 1, further comprising:
a query update data storer configured for storage of query update data for association of update conditions for use to query update determinations and update rules for update of query; and
a query updater configured for collation of a query with the update conditions of query update data, to update the query in accordance with a update rule, wherein
the supply data transmitter is adapted to transmit a supply data containing a new query updated by the query updater.

7. The information supplying server according to claim 3, further comprising:
a query update data storer configured for storage of query update data for association of update conditions for use to query update determinations and update rules for update of query; and
a query updater configured for collation of a query with the update conditions of query update data, to update the query in accordance with a update rule, wherein
the supply data transmitter is adapted to transmit a supply data containing a new query updated by the query updater.

8. An information supplying server configured to retrieve information matching a query composed of a keyword as a retrieval key word, to supply to a client terminal, the information supplying server comprising:
a retrieval destination data storer configured for storage of retrieval destination data for association of superordinate concepts of keywords, and retrieval destination identifiers for identification of retrieval servers adapted to supply information retrieved by a keyword of superordinate concept;
a retrieval request receiver configured to receive a query containing a keyword from the client terminal;
a retriever configured to transmit a received query to a retrieval server identified by a retrieval destination identifier associated with a superordinate concept of a received keyword in the retrieval destination data, and receive retrieved data from the retrieval server;
a query update data storer configured for storage of query update data for association of update conditions for use to query update determinations and update rules for update of query;
a query updater configured for collation of a query with the update conditions of query update data, to update the query in accordance with a update rule; and
a supply data transmitter configured to transmit a supply data containing a new query updated by the query updater.

9. The information supplying server according to claim 1, wherein
the retrieval destination data associates superordinate concepts of keywords and retrieval destination identifiers with identifiers of retrieval methods for use to information retrieval, and
the retriever is adapted, with a received retrieval request designating a retrieval method, to transmit a query to a retrieval server identified by a retrieval destination identifier associated with an identifier of the retrieval method.

10. The information supplying server according to claim 3, wherein
the retrieval destination data associates superordinate concepts of keywords and retrieval destination identifiers with identifiers of retrieval methods for use to information retrieval, and
the retriever is adapted, with a received retrieval request designating a retrieval method, to transmit a query to a retrieval server identified by a retrieval destination identifier associated with an identifier of the retrieval method.

11. The information supplying server according to claim 8, wherein
the retrieval destination data associates superordinate concepts of keywords and retrieval destination identifiers with identifiers of retrieval methods for use to information retrieval, and
the retriever is adapted, with a received retrieval request designating a retrieval method, to transmit a query to a retrieval server identified by a retrieval destination identifier associated with an identifier of the retrieval method.
